(19) United States
(12) Patent Application Publication
(10) Pub. No.: US 2019/0263649 A1
(43) Pub. Date: Aug. 29, 2019

(54) Funnel with Spill-Stop Valve

(71) Applicant: James Buhler, Waterford, WI (US)

(72) Inventor: James Buhler, Waterford, WI (US)

(21) Appl. No.: 16/285,973

(22) Filed: Feb. 26, 2019

Related U.S. Application Data
(60) Provisional application No. 62/635,094, filed on Feb. 26, 2018.

(51) Int. Cl. B67C 11/06

(52) U.S. Cl. CPC B67C 11/066

(57) ABSTRACT

An apparatus for minimizing spilling of liquids poured into a container, the apparatus comprising a funnel structure and a float member. The funnel structure has an open top portion extending to a flow aperture open into a spout extending downwardly beyond an almost-full level. The float member is movable within the spout and configured and dimensioned such that a float top is forced into a sealing engagement with the flow aperture by a liquid reaching the almost-full level below an empty head space reserved for draining the liquid from the top portion by lifting the funnel structure thus disengaging the flow aperture from the float member. The top portion may have a frusto-conical shape tapering from an open mouth to the flow aperture.

### RELATED APPLICATION

This application claims the benefit of U.S. Provisional Application Ser. No. 62/635,094, filed Feb. 26, 2018. The entirety of the contents of Application Ser. No. 62/635,094 are incorporated herein by reference.

### FIELD OF THE INVENTION

The present invention relates to funnels for pouring liquids into containers through a narrowed neck opening and, more particularly, to devices for preventing spilling of the liquid due to overfilling of the container.

### BACKGROUND OF THE INVENTION

Funnels are typically used to handle and transfer materials and to fill containers. A funnel is generally a conical device having a small hole or narrow tube or stem at the apex which is used to channel the flow of a substance, as into a small-mouthed container. A funnel has a relatively wide open upper end into which a user may pour liquids or other pourable substances and a relatively narrow lower end or stem. The stem generally functions to direct the flow of the pourable substances into the container and is positioned into the neck or mouth of a container.

In a typical use of a funnel, a user pours a substance into the funnel to fill a container to a certain volume. One problem encountered in pouring a substance into a container that is not fully transparent is that a user may not be able to see the increasing volume of the substance in the container. The user may also be careless and pour too much substance into a container through a funnel. It is easy to overfill a container or spill liquids despite the use of a funnel.

There is a need to provide an improved funnel for the handling and transferring of materials. There is a need to provide funnel devices that prevent spills and overfilling when using a funnel to transfer pourable substances.

### SUMMARY OF THE INVENTION

The present invention relates to an apparatus for minimizing spilling of liquids poured into a container. The inventive apparatus includes a funnel structure and a float member. The funnel structure has an open top portion extending to a flow aperture which opens into a spout. The spout extends downwardly beyond an almost-full level of the container when liquid is poured through the funnel structure.

The float member is movable within the spout and is dimensioned to extend from the flow aperture and beyond the almost-full level along the spout. The float member is also so dimensioned within the spout and is configured to be buoyant such that a float top is forced into a sealing engagement with the flow aperture by a liquid reaching the almost-full level below an empty head space reserved for draining the liquid from the top portion by lifting the funnel structure, thus disengaging the flow aperture from the float member.

The top portion may have a frusto-conical shape tapering from an open mouth to the flow aperture. Other suitable shapes of the top portion may also be utilized in the present invention.

The spout defines a flow passage which terminates at a bottom end of the spout. In some embodiments, the flow passage may have a greater diameter than the flow aperture. In some of such embodiments, the spout has a spout wall which may extend from the top portion offset around the flow aperture.

In certain embodiments, the spout may have a retaining structure retaining the float member within the flow passage. The retaining structure may include a retaining rod extending across the bottom end of the flow passage. Alternatively or in combination, the retaining structure may include a plurality of protrusions extending inwardly from a spout wall at the bottom end of the flow passage. In some of such embodiments, the float member may have a sidewall extending along the spout wall outwardly of the retaining-structure protrusions. The protrusions of the retaining structure may engage the float member along a bottom of the sidewall, thereby stopping the float member from exiting the bottom end of the flow passage of the spout.

The float top may be convex or have other suitable configuration for sealing engagement with the flow aperture. In some embodiments, the float member forms a closed chamber extending between the float top and a chamber bottom.

In certain embodiments, the float member has a substantially cylindrical sidewall forming the chamber and extending along a spout wall. In addition or in combination, the float member may have a sidewall including a plurality of vertical grooves forming flow channels along the spout wall. In some of such embodiments, the protrusions of the retaining structure engage bottom edges of the float-member sidewall between the grooves.

The float member may have a substantially flat bottom cap sealing the chamber. In certain embodiments, the bottom cap may extend downwardly below bottom edges of the sidewall of the float member.

The funnel structure may include a positioning collar extending outwardly from a spout wall adjacent to a flow aperture. The positioning collar may be spaced from the top portion.

In certain embodiments, the spout wall may define at least one venting hole adjacent the flow aperture to relieve air trapped between the liquid poured into the spout and through the flow aperture and a rising surface of the liquid in the container.

### BRIEF DESCRIPTION OF THE DRAWINGS

FIG. 1 is a schematic cross-sectional view of an exemplary embodiment of the inventive funnel with a valve shown blocking flow of excess substance into a full container.

FIG. 2 is another schematic cross-sectional view of the exemplary embodiment of FIG. 1 of the inventive funnel with a valve position for open flow through the funnel.

FIG. 3 is a fragmental perspective view showing elements of the present invention with the valve open for flow through the funnel.

FIG. 4 is a fragmental perspective view showing elements of the present invention with the valve blocking flow through the funnel.

FIG. 5A is an exploded perspective view of one example of the present invention, showing a float member outside of the funnel.

FIG. 5B is an exploded perspective view of another example of the present invention, showing a float member outside of the funnel.

FIG. 6 is a perspective view of the funnel of FIG. 5B.

FIG. 7 is an enlarged perspective view of the float member of FIG. 5.

FIG. 8 is a perspective view of another embodiment of a funnel structure according to the present invention with a float member retained inside a flow passage by a retaining rod.

FIG. 9 is a top view of the funnel structure according to the present invention with an open flow aperture.

FIG. 10A is a bottom view of the funnel structure of FIG. 5A showing a retaining rod that maintains the float member within the flow passage.

FIG. 10B is a bottom view of the funnel structure of FIG. 8 showing an exemplary retaining structure that maintains the float member within the flow passage.

FIG. 11 is a perspective view of the funnel structure of FIG. 8 with the float member in sealing engagement with the flow aperture.

FIG. 12A is another perspective view of the funnel structure of FIG. 8 with the flow aperture being open for flow.

FIG. 12B is a perspective view of the funnel structure of FIG. 5A with the flow aperture being open for flow.

FIG. 13 is a fragmentary perspective view of the funnel structure of FIG. 8 illustrating relative dimensioning of the float member, a spout portion and spacing of an outward collar with respect to the flow aperture.

FIG. 14 is another fragmentary perspective view of the funnel structure of FIG. 8 shown with an adjustment collar extending outwardly beyond the outward collar seen in FIG. 13.

FIG. 15 is a top perspective view of the funnel structure of FIG. 14 shown with the combination of the adjustment and outward collars.

FIG. 16 is a perspective view of the funnel structure of FIG. 14 positioned on an open top of an exemplary container which is transparent for illustrative purposes showing that the container is not yet full and may accept more liquid and that the float member remains below the flow aperture.

FIG. 17 is a top perspective view of the funnel structure of FIG. 16 showing that the flow aperture is open for flow.

FIG. 18 is a top perspective view of the funnel structure of FIG. 16 showing the flow aperture closing to any flow as the rising liquid level in the container reaches the almost-full level and activates the shut-off valve.

FIG. 19 is a perspective view of the funnel structure of FIG. 18 and showing that the container is full such that the float top is in sealing engagement with the flow aperture with the surface of the liquid at the almost-full level while reserving a head space in the container above to accommodate liquid drained from the top portion of the funnel upon lifting of the funnel structure from the container.

FIG. 20 is a fragmentary perspective view of FIG. 19 showing details of the float member and the head space remaining in the container after the flow passage is closed to flow by the float top being pushed into sealing engagement with the flow aperture.

### DETAILED DESCRIPTION OF PREFERRED EMBODIMENT

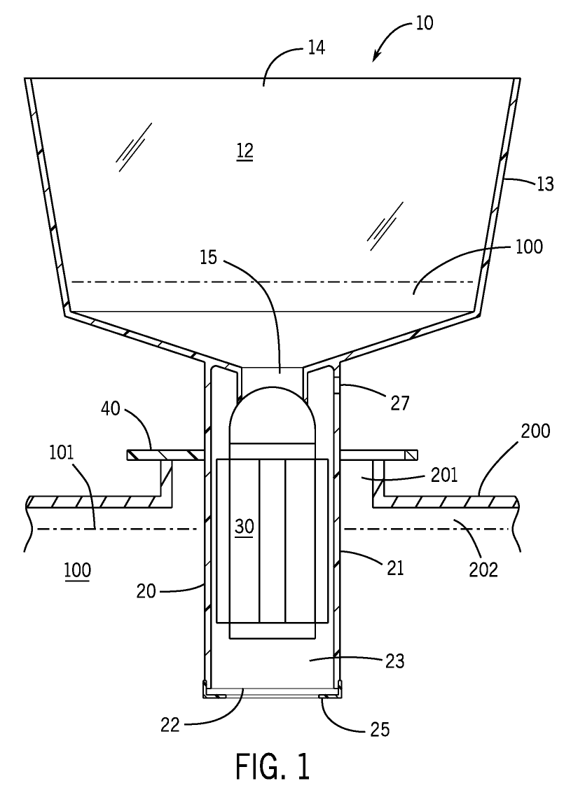

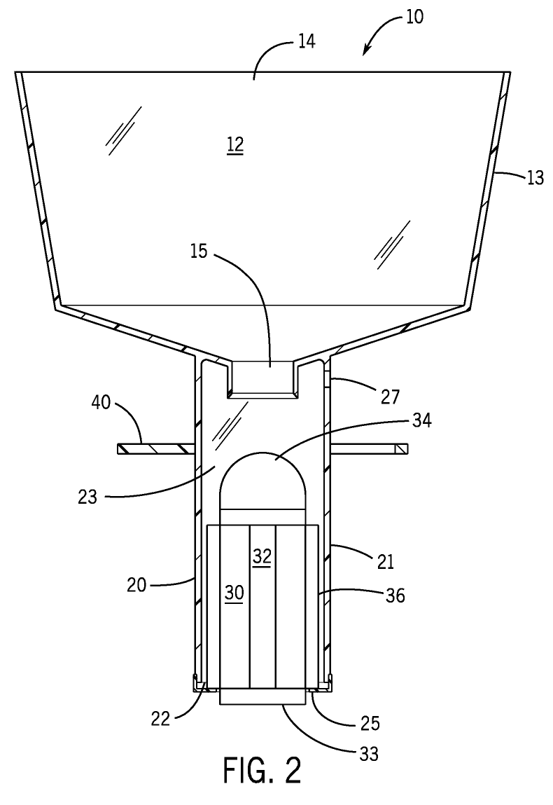

The figures show exemplary embodiments of a funnel structure 10 which includes a top portion 12 and a spout portion 20. Top portion 12 is shown to have an exemplary generally frusto-conical wall 13 defining a wide open mouth 14 and extending to a smaller flow aperture 15 open into spout portion 20. Spout portion 20 has a spout wall 21 which defines a flow passage 23 and extends from frusto-conical wall 13 to a bottom end 22. FIGS. 1 and 2 show that flow passage 23 may have a greater diameter than flow aperture 15 and that spout wall 21 may extend from frusto-conical wall 13 around the aperture 15.

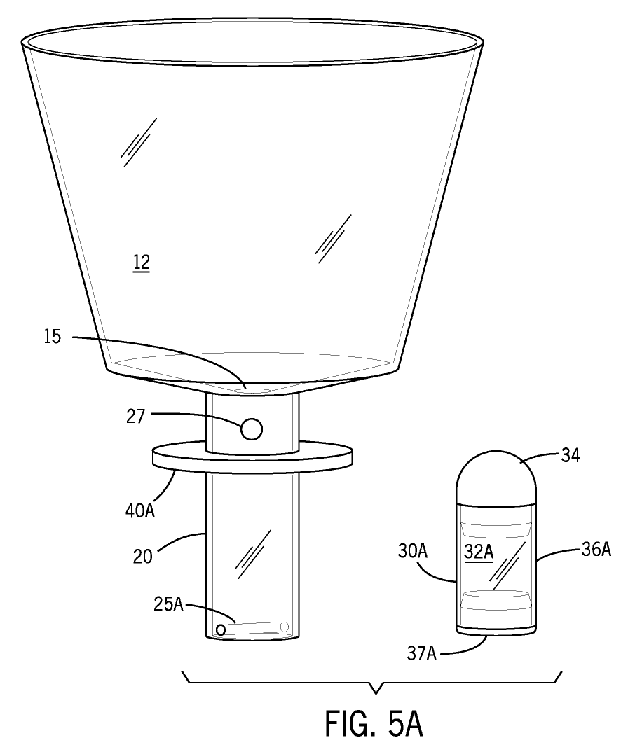

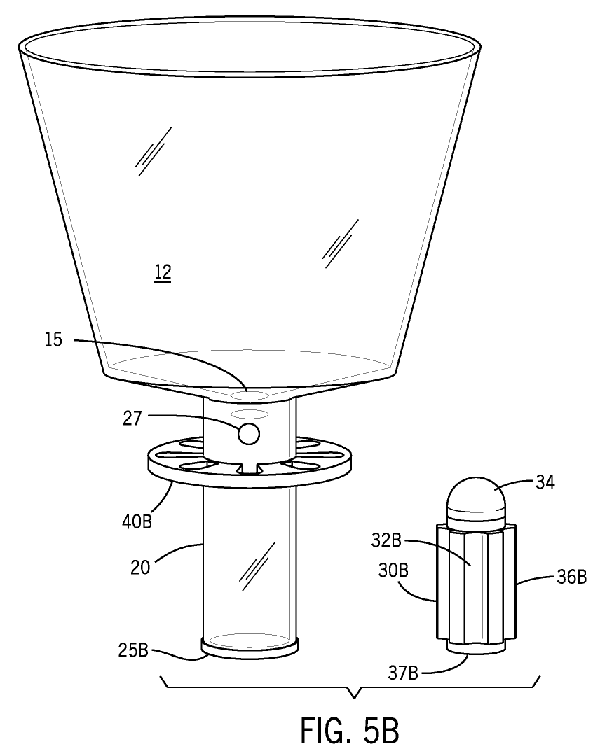

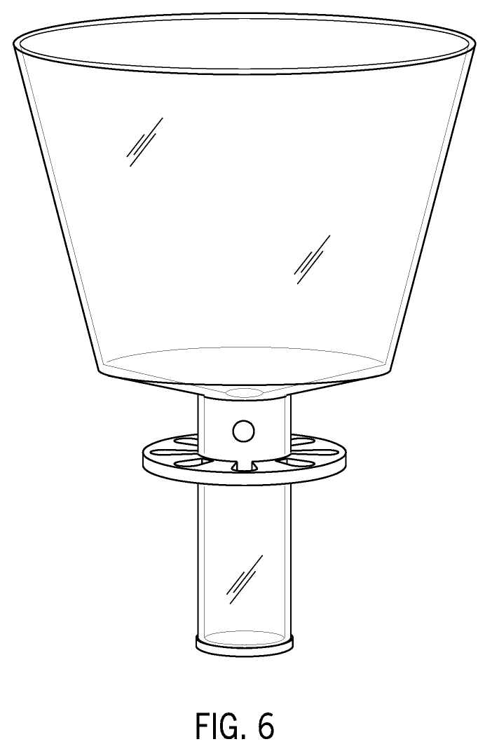

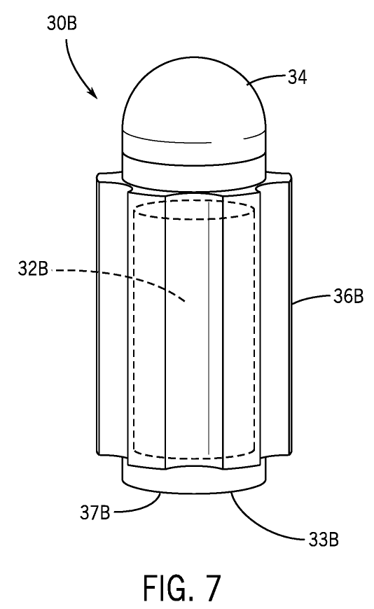

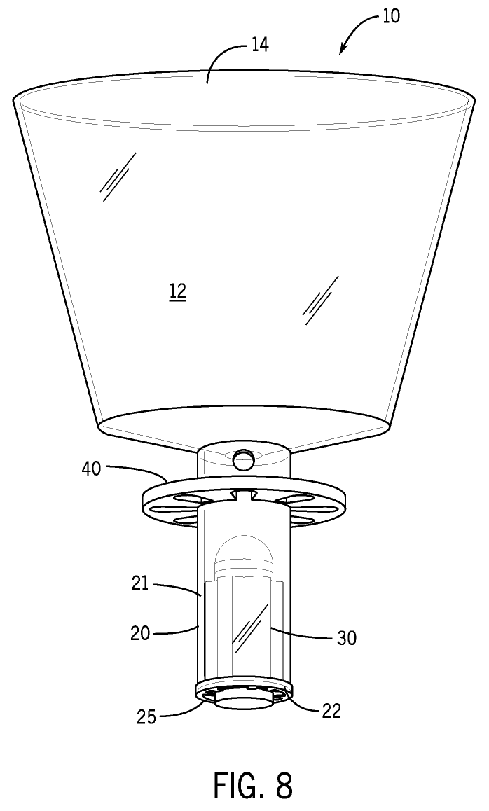

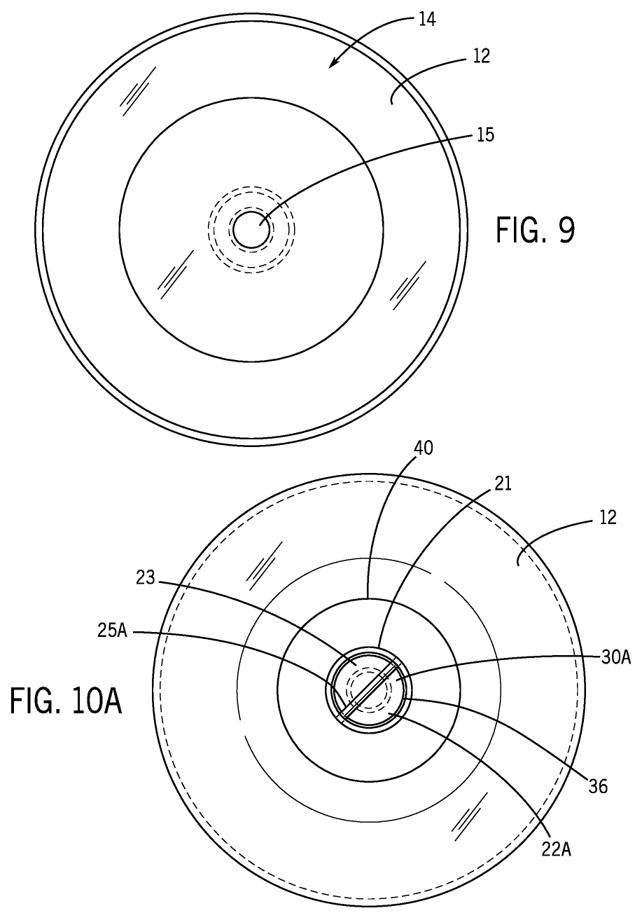

A float member 30 is positioned within flow passage 23. Examples of float member 30 are best seen in FIGS. 5A, 5B and 7. FIG. 5A shows an example of float member 30A having a substantially cylindrical sidewall 36A for extending along spout wall 21 and forming a closed chamber 32A extending between a closed chamber bottom end 33 and a float top 34. The example of float member 30 show in FIG. 5A has a substantially flat bottom cap 37A which seals chamber 32 and forms chamber bottom end 33. FIGS. 5B and 7 show another example of float member 30B having a sidewall 36B with vertical grooves forming flow channels along spout wall 21, as also seen in FIG. 8. Some alternative embodiments may include a combination of the illustrated embodiments. For example, chamber 32A may be positioned inside grooved sidewall 36B.

The present invention may be used with a variety of pourable substances which, for convenience, will be referred to as liquid 100. Top 34 is configured and dimensioned for sealing flow aperture 15 to stop any flow of liquid 100 from top portion 12 into spout portion 20. FIG. 7 shows an example of top 34 having a convex configuration which facilitates sealing engagement with flow aperture 15.

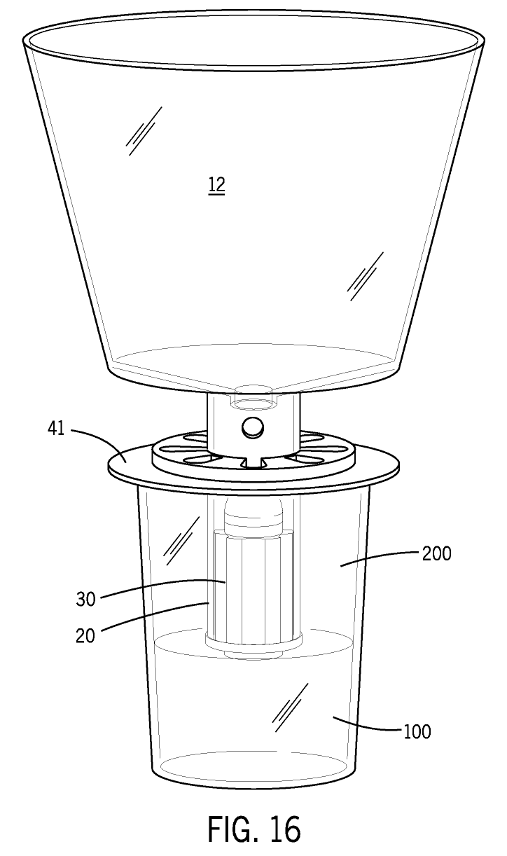

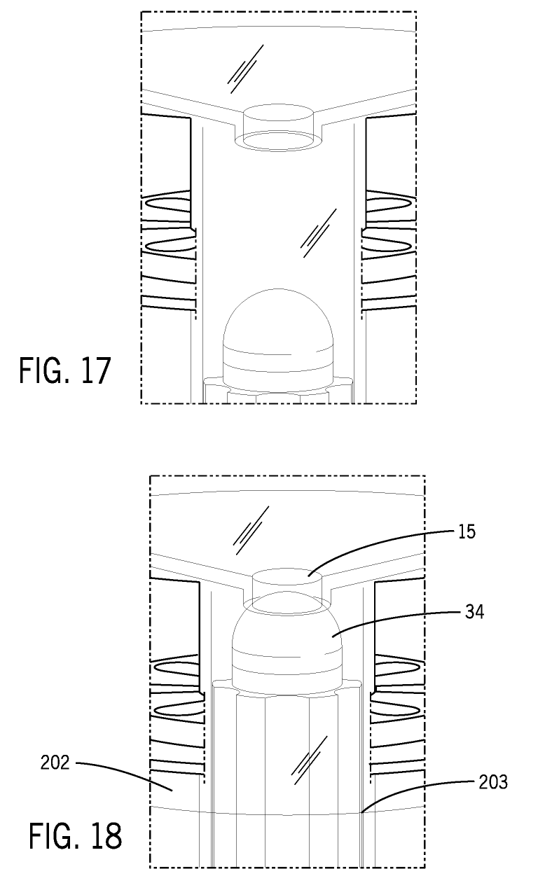

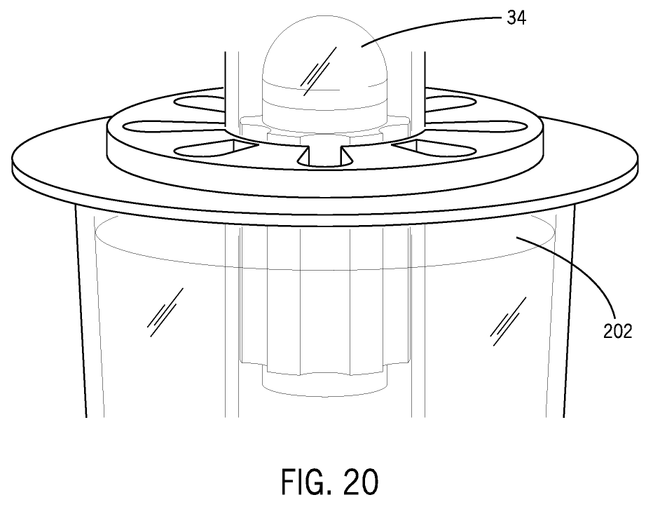

Chamber 32 may be empty (have a vacuum) or be filled with a suitable gas such as air. FIG. 7 shows an example of chamber 32B as being a void formed by an outer structure of float member 30B. It should be understood that alternative suitable configurations of float structures may be used in accordance with the present invention. The float member 30 of the present invention is configured to have such buoyancy that maintains float top 34 above a surface 101 of liquid 100 poured into a container 200, as illustrated in FIGS. 16-20.

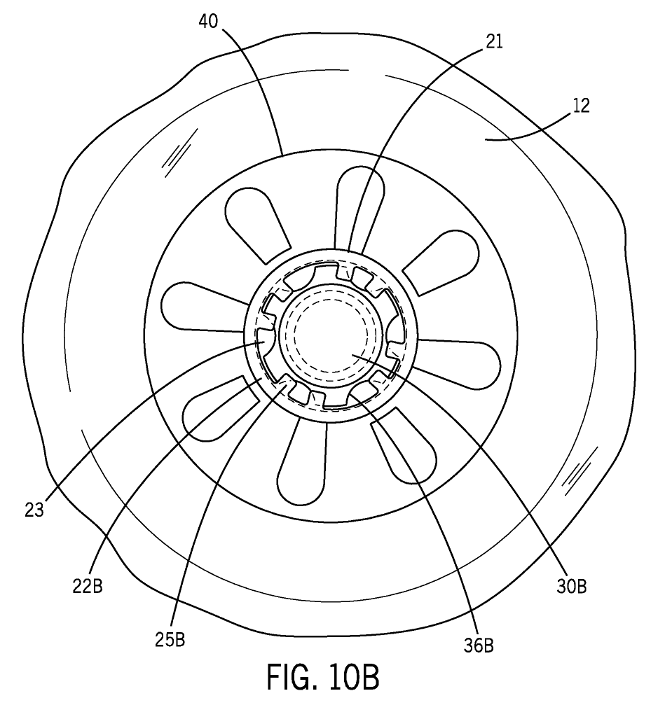

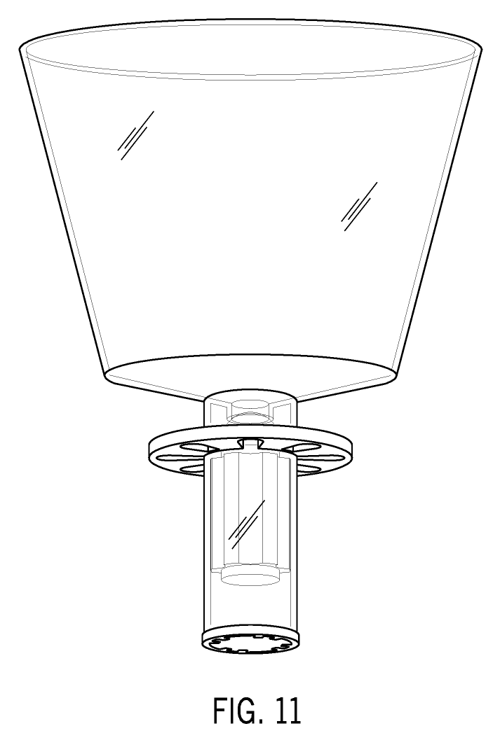

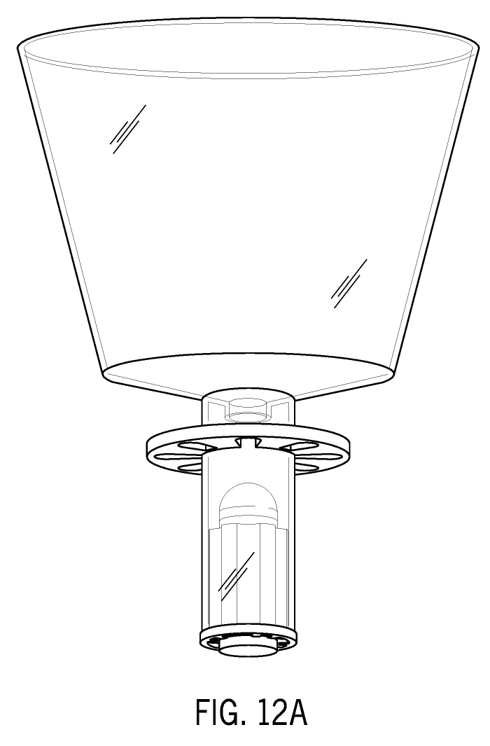

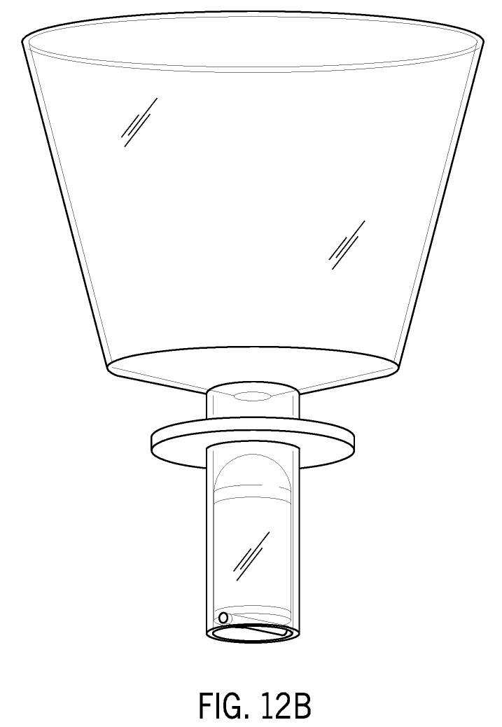

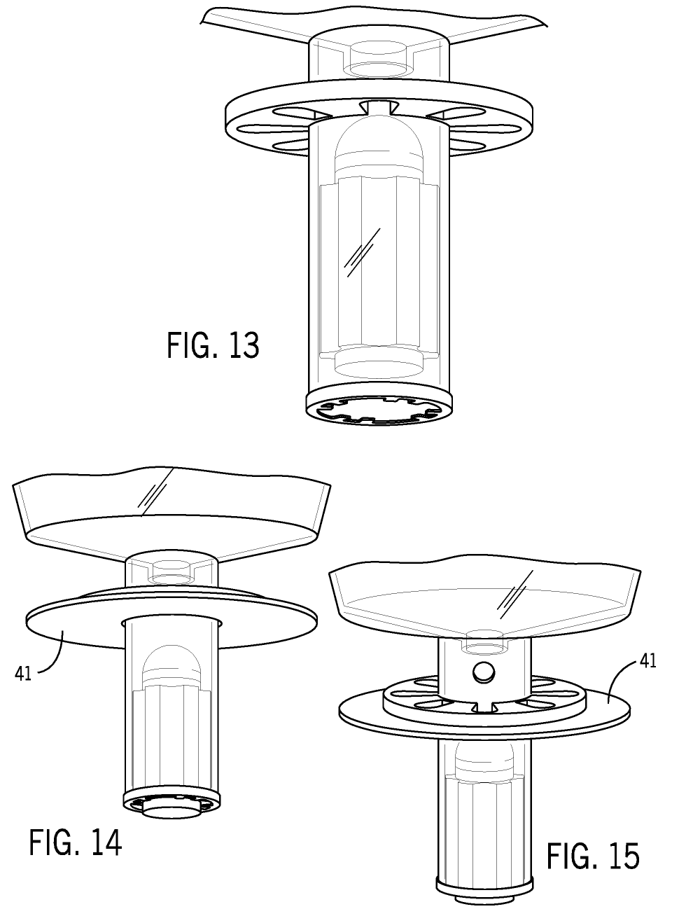

Float member 30 can be retained within passage 23 by a retaining structure 25. FIGS. 5A and 10A show retaining structure including rod 25A extending across bottom end 22A of flow passage 23. These FIGURES illustrate rod 25A extending through opposite sides of sidewall 21 of spout 20. FIG. 10B best illustrates an alternative float-retaining structure which includes protrusions 25B inwardly protruding from spout wall 21. FIG. 10B also shows protrusions 25B engaging bottom edges of sidewall 36B between the grooves of float member 30B. Features of retaining structures 25A and 25B alone or in combination may be used to retain float member 30 within flow passage 23.

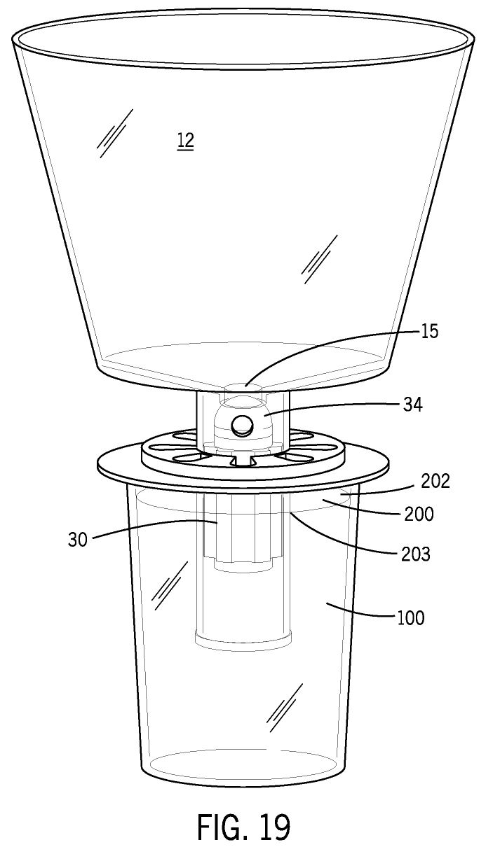

In certain embodiments of the present invention, funnel structure 10 includes a positioning collar 40 extending outwardly from spout wall 21 adjacent to flow aperture 15. An exemplary embodiment shown in FIGS. 14-20 includes an adjustment collar 41 accommodating containers 200 with larger diameter neck openings 201, as seen in FIGS. 16 and 19. Alternatively, collar 40 may be sized to accommodate various diameter neck openings 201, including large diameter neck openings, as shown in FIGS. 16 and 19.

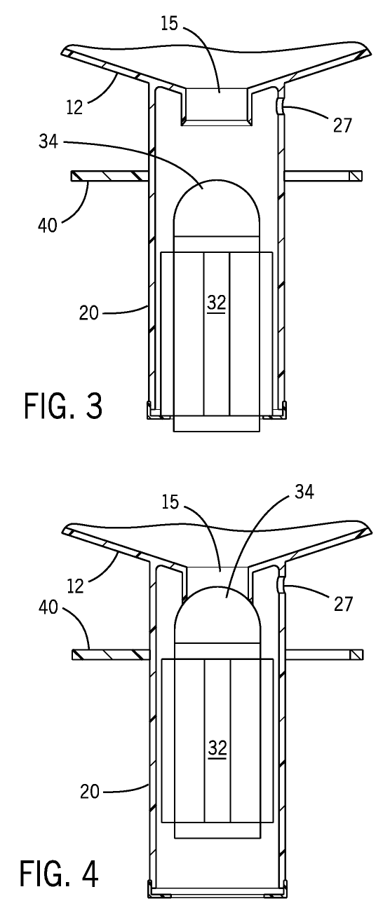

It is seen in FIGS. 1-5 that positioning collar 40 is spaced from top portion 12. FIGS. 1-3 also show at least one venting hole 27 formed through spout wall 21 to relieve the pressure of air trapped between flow aperture 15 and the rising level of liquid 100 poured into container 200 through spout portion 20 of funnel structure 10.

FIGS. 16-20 illustrate that dimensions and buoyancy of float member 30 with respect to dimensions of spout portion 20 extending downwardly beyond an almost-full level 203 and spacing of outward collar 40 with respect to flow aperture 15 are chosen to provide a head space 202 in the container after float top 34 seals flow aperture 15. Head space 202 is no less than a possible volume of liquid that may remain in top portion 12 above flow aperture 15 when it is sealed due to the rising level of liquid 100 filling container 200. As particularly seen in FIGS. 18-20, float top 34 is forced into a sealing engagement with flow aperture 15 by liquid 100 reaching almost-full level 203 below empty head space 202 which is reserved for draining liquid 100 which remains in the top portion 12 after sealing flow aperture 15. Top portion 12 is emptied by lifting funnel structure 10 thus, disengaging flow aperture 15 from top 34 of float member 30. In other words, the funnel structure according to this invention reserves sufficient space for safe draining of the remaining liquid 100 directly into container 200.

While the principles of the invention have been shown and described in connection with specific embodiments, it is to be understood that such embodiments are by way of example and are not limiting.

1. An apparatus for minimizing spilling of liquids poured into a container, the apparatus comprising:
a funnel structure having an open top portion extending to a flow aperture open into a spout extending downwardly beyond an almost-full level; and
a float member movable within the spout and configured and dimensioned such that a float top is forced into a sealing engagement with the flow aperture by a liquid reaching the almost-full level below an empty head space reserved for draining the liquid from the top portion by lifting the funnel structure thus disengaging the flow aperture from the float member.

2. The apparatus of claim 1 wherein the top portion has a frusto-conical shape tapering from an open mouth to the flow aperture.

3. The apparatus of claim 1 wherein the spout defines a flow passage terminating at a bottom end.

4. The apparatus of claim 3 wherein:
the flow passage has a greater diameter than the flow aperture; and
the spout has a spout wall extending from the top portion offset around the flow aperture.

5. The apparatus of claim 3 wherein the spout comprising a retaining structure retaining the float member within the flow passage.

6. The apparatus of claim 5 wherein the retaining structure includes a retaining rod extending across the bottom end of the flow passage.

7. The apparatus of claim 6 wherein:
the retaining structure comprises a plurality of protrusions extending inwardly from a spout wall at the bottom end of the flow passage; and
the float member has a sidewall extending along the spout wall outwardly of the retaining-structure protrusions which engage the float member thereby stopping the float member from exiting the bottom end of the flow passage of the spout.

8. The apparatus of claim 1 wherein the float top is convex.

9. The apparatus of claim 1 wherein the float member forms a closed chamber extending between the float top and a chamber bottom.

10. The apparatus of claim 9 wherein the float member has a substantially cylindrical sidewall forming the chamber and extending along a spout wall.

11. The apparatus of claim 10 wherein the float member has a substantially flat bottom cap sealing the chamber.

12. The apparatus of claim 1 further comprising a positioning collar extending outwardly from a spout wall adjacent to a flow aperture.

13. The apparatus of claim 12 wherein the positioning collar is spaced from the top portion.

14. The apparatus of claim 1 wherein a spout wall defines at least one venting hole adjacent the flow aperture to relieve air trapped between the liquid poured through the spout and a rising surface of the liquid in the container.
